(19) United States
(12) Patent Application Publication
(10) Pub. No.: US 2007/0174362 A1
(43) Pub. Date: Jul. 26, 2007

(54) System and methods for secure digital data archiving and access auditing

(76) Inventors: Duc Pham, Cupertino, CA (US); Tien Le Nguyen, Cupertino, CA (US)

Correspondence Address: GERALD B ROSENBERG;NEW TECH LAW, 260 SHERIDAN AVENUE, SUITE 208, PALO ALTO, CA, 94306-2009, US

(21) Appl. No.: 11/334,710

(22) Filed: Jan. 18, 2006

(51) Int. Cl. G06F 17/30

(52) U.S. Cl. 707/204

(57) ABSTRACT

On an archive server, a secure storage control layer is interposed in the archive data stream between an archiving application and a storage device driver. The secure storage control layer includes an encryption engine providing for two-level cipher processing of data segments transported by the stream. A secure policy controller is coupled to the secure storage control layer and, responsive to identifying information obtained from the stream, retrieves a group of encryption keys from a secure storage repository to enable the encryption engine to selectively encrypt data segments or a single encryption key conditionally enabling the encryption engine to decrypt select data segments. For both encryption and decryption, the integrity of the stream is maintained allowing operation of the secure storage control layer to be functionally transparent to the archiving application and storage device driver.

### BACKGROUND OF THE INVENTION

1. Field of the Invention

The present invention is generally related to the digital data archiving systems and, in particular, to a system and methods of enabling the secure archiving and retrieval of digital data subject to access management and auditing controls.

2. Description of the Related Art

The desire and need for long term retention of personal and business data creates a complex set of problems that have not been adequately addressed to date. These problems are particularly acute for various business and scientific organizations that accumulate substantial volumes of data on a daily if not continuous basis and further expect to accumulate ever growing volumes going forward. Security concerns, particularly whenever personal data and critical business data are involved, and other factors, including regulatory and insurance requirements, impose significant complexities on the ongoing creation and maintenance of large scale data archives. Archives of comparably modest size are also subject to the same management requirements and thus encounter most if not all the same complexities.

Even beyond the complexities of organizing and controlling the ordered storage of large volumes of data, essentially arbitrary retrieval must be supported at any point within the lifetime of an archive. Particularly for business records, reliably access to archived data records is required for periods likely exceeding thirty years. Not only does the data need to be fully identifiable and recoverable, but the particular security concerns associated with particular data records, in place at the time of creation, need to be continuously maintained and enforced.

Given the size and structural diversity of business and scientific organizations, often reaching a global scope even when just considering data retention concerns, there are also fundamental requirements for archiving scalability and throughput performance. Where terabytes and more need to be archived in a matter of hours, organizations will typically implement automated tape library systems supporting the parallel striping of data to large tape drive arrays. Where the speed and capacity requirements outweigh cost issues, library systems utilizing disk drive arrays are commonly used.

Sophisticated, often proprietary backup application program and driver systems are used to manage these libraries. An inherent concern, however, is that if data security and retrieveability are dependent on proprietary hardware or software, then that hardware and software must be maintainable for the full life of the archived data. A known, but conventionally unmet desire is for archived data is to be free of such storage system dependencies, yet without compromise of the data security originally employed by those systems in the creation of data archives.

Particularly in certain publishing, data mining, and similar industries, various segments of a data archive must be maintained readily accessible for analysis and other uses during the full lifetime of the archive. These types of data releases are often limited, if not precluded, due to the unavailability of automated mechanisms for auditing, authorizing, and securely controlling individual data release transactions.

Even where an archive access transaction is permitted, a related concern is securely controlling the scope of access permitted and keeping a clear and detailed audit trail of each access. Whenever a secure access key is released in some capacity to a third party, there are limited controls that prevent use of the key to access other data secured by the same key. Conventionally, security keys are periodically rotated to enforce a compartmentalization of the secure data. Key rotation, however, imposes an additional burden on the already complex problem of accurately and securely maintaining password keys for all of the data accumulated in a data archive. Given that many different entities, including owners of different data aspects, regulators, affiliates, licensees of divisible data rights, and various system operators, should have different and detailed access controls applied to their uses, conventional security systems are generally unable to define and maintain separate password keys for such fine grained access, even without achieving the further desire of supporting and enforcing key rotation.

Consequently, there is a fundamental need for a consistent data archiving, security, and auditing system that supports the creation and long term management of fundamentally portable data archives.

### SUMMARY OF THE INVENTION

Thus, a general purpose of the present invention is to provide an efficient system and methods of creating and retrieving archive data in a secure, portable, and auditable manner.

This is achieved in the present invention by providing, on an archive server, a secure storage control layer interposed in the archive data stream between an archiving application and a storage device driver. The secure storage control layer includes an encryption engine providing for cipher processing of data segments transported by the stream. A secure policy controller is coupled to the secure storage control layer and, responsive to identifying information obtained from the stream, retrieves a group of encryption keys from a secure storage repository to enable the encryption engine to selectively encrypt data segments or preferably a single encryption key conditionally enabling the encryption engine to decrypt select data segments. For both encryption and decryption, the integrity of the stream is maintained allowing operation of the secure storage control layer to be functionally transparent to the archiving application and storage device driver.

The two-level encryption is preferably implemented in the present invention in a process that operates on data units, which include a unit metadata header and a data segment, transferred as part of the archive data stream. For each of a series of archive data units, the process includes selecting a segment encryption key corresponding to a predetermined data unit, first encrypting said data segment of said predetermined data unit with the segment encryption key to produce an encrypted data segment, second encrypting the segment encryption key by each of a set of security control encryption keys and storing the segment encryption key, as encrypted, in a security metadata header, and packaging the unit metadata header, the security metadata header and the encrypted data segment as said replacement data unit in the archive data stream.

Access to the archive data is securely managed by selectively controlling the retrieval of any of the security control encryption keys that would allow decryption of the segment encryption key. For each of a series of archive data units, the process includes retrieving a security control encryption key from a secure repository, conditionally subject to a security policy that determines the user groups that may retrieve a corresponding security control encryption key, using the security control encryption key to decrypt from a security metadata header the corresponding segment encryption key, decrypting the corresponding encrypted data segment, and packaging the unit metadata header, and the decrypted data segment as a replacement data unit in the archive data stream.

An advantage of the present invention is that archived data is reliably secured effectively transparent to the particular implementation of the archiving application and underlying archive driver and devices. Consequently, access, subject to long term maintenance of the archive data, can be assured. In addition, the security controls governing access to the archived data are flexible and allow for access by multiple security policy defined groups.

Another advantage of the present invention is that implementations of the present invention are readily adaptable to and support high performance, scaleable, data archiving system architectures. The security control driver layer as typically implemented by the present invention is easily installed and maintained in well-established conventional archiving system architectures. Once installed, subject to ordinary policy management maintenance, the operation of the present invention is very nearly if not fully automated.

A further advantage of the present invention is that the system supports and enforces security policy defined key management controls. Multiple security keys can be defined on an essentially per-storage-unit basis, allowing implementation of fine grained, cross-cutting concern security controls over access to the archived data. The policy defined key management controls also enables full key rotation for all keys automatically or by minimal, centralized management of the key policies.

Still another advantage of the present invention is a variety of implementation architectures are supported enabling use in a variety of configurations and controlled uses. The secure key repositories can be flexibly implemented as local and remote software-based modules or on security control appliance. Access to archived data can be constrained to specific authenticated users or to defined user groups provided with a group authentication identifier. In the latter instance, an affiliate reader-only mode of use is supported, allowing a known generic group of users to securely access archive data, even though the specific identities of the users may not be known at the time of archive creation and do not subsequently require user explicit identification in the security policies to allow controlled access. Revocation of a user or group security policy identification effectively terminates all subsequent access to the archive data, thus ensuring continuing security control.

Yet another advantage of the present invention is that full auditing of archive data access is automatically supported through the required use of the secure key repositories. Each access of the repository to obtain an encryption key is subject to security policy evaluation and, concurrently, attempt and action logging by the repository server. This auditing allows comprehensive examination and management of the archive data use.

### BRIEF DESCRIPTION OF THE DRAWINGS

FIG. 1 is an architectural block diagram of a distributed archiving system implementing a preferred embodiment of the present invention;

FIG. 2 is a simplified block diagram illustrating a logical archive data stream incorporating multiple archiving data sessions;

FIG. 3 is a simplified system block diagram of illustrating the interleaving acquisition of archive data streams in accordance with a preferred embodiment of the present invention;

FIG. 4 provides a block diagram illustrating an interleaved archive data stream produced by an archiving application in accordance with a preferred embodiment of the present invention;

FIG. 5 is a block diagram of an interleaved archive data stream as processed in accordance with a preferred embodiment of the present invention to provide for the selective encryption of archive unit data segments;

FIGS. 6A and 6b provide state diagrams illustrating preferred processes of validating and enabling the encryption and decryption of content data segments in accordance with preferred embodiments of the present invention;

FIG. 7 is a block diagram of a archive security controller providing for the processing of an archive session data header in accordance with a preferred embodiment of the present invention;

FIG. 8 is a block diagram of a archive security controller providing for the processing of archive units to produce secure archive units in accordance with a preferred embodiment of the present invention;

FIG. 9 is a simplified process diagram illustrating the preferred procedure for generating secure key groups for use in connection with a preferred embodiment of the present invention;

FIG. 10 is a simplified process diagram illustrating a preferred method of providing for the secure and recoverable encryption of an archive unit data segment in accordance with a preferred embodiment of the present invention;

FIG. 11 is a block diagram of a archive security controller providing for the processing of secure archive units to produce clear text archive units in accordance with a preferred embodiment of the present invention;

FIG. 12 is a block diagram of a secure repository server implemented in accordance with a preferred embodiment of the present invention;

FIG. 13 is a system block diagram illustrating a deployment architecture supporting either or both use of local and remote secure key repositories in accordance with a preferred embodiment of the present invention; and

FIG. 14 is a system block diagram illustrating a deployment architecture supporting affiliate or reader-only archive data access systems as implemented in accordance with a preferred embodiment of the present invention.

### DETAILED DESCRIPTION OF THE INVENTION

Given the volume of data conventionally required to be archived on a routine if not continuous basis, much of the architectural development of archiving systems has been directed to the development of fast, scaleable, if not inherently large scale archive device libraries and correspondingly complex and frequently proprietary archiving control applications. Tape and disk libraries supporting terabytes of online storage and petabytes of robotically accessible, offline storage are not uncommon. The growth in archived data is generally matched by the increasing need to ensure future accessibility and secure control over those entities allowed to access the data.

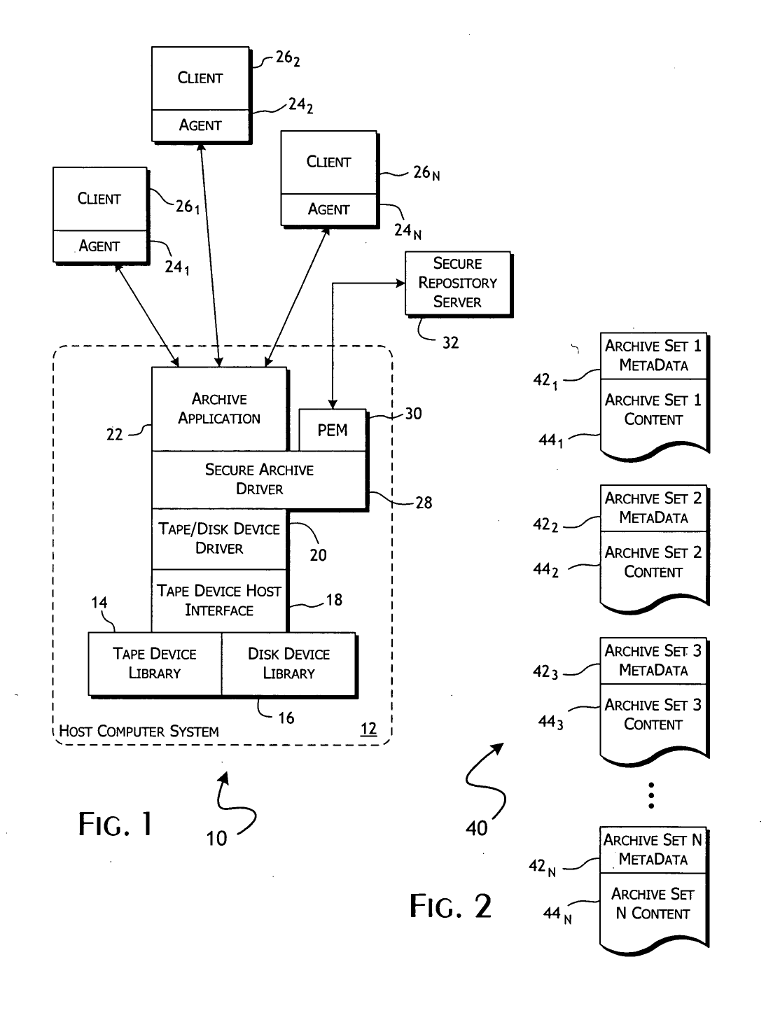

Conventional archive data system architectures are generally of the form 10 shown in FIG. 1. A host computer system 12, implemented as a single or parallel array of archive servers, supports some combination of tape drive 14 and disk drive 16 media-based libraries. The library hardware system 14, 16 will typically implement a standard interface 18, such as a multi-channel fiber channel controller, and a vendor supplied device driver 20 to enable integration with the host computer system 12. While the hardware system 14, 16 and even interface 18 may be proprietary, the device driver 20 is typically configured to emulate, relative to an archiving application 22, a standard or at least well-defined automated archiving systems. Typical emulation targets include the various conventional and widely adopted automated tape libraries from StorageTek®, Quantum®, ADIC®, HP® and other competitive archive system manufacturers.

A third-party archiving application 22, such as VERITAS NetBackup™, VERITAS Backup Exec™, Legato NetWorker™, CommVault® Galaxy™, IBM® Tivoli® Storage Manager, Computer Associates BrightStor®, and BakBone® NetVault™, is typically able to interface with one if not several of these de-facto standard tape library device drivers. These archiving applications 22, in various forms, support distributed agent modules 24_{1-N} that enable typically distributed client data systems 26_{1-N} to be accessed and transfer data for archiving to the host computer system 12. Data to be archived is typically collected and streamed over an internet or intranet network connection to the archive application 22.

As generally represented in FIG. 2, archive data streams are at least logically collected and persisted on archive devices 14, 16 as a series of archive data sets or sessions 40. Each archive session is identified by a session metadata header 42_{1-N} and followed, again at least logically, by the associated archive data content 44_{1-N}. The archive session metadata header 42_{1-N} is typically a proprietary data structure created and defined by the archive application 22 to describe the source of the archived data and the form and nature of the archive data content 44_{1-N} collected into the corresponding archive data session 40.

In accordance with the preferred embodiments of the present invention, referring again to FIG. 1, a secure archive driver 28 is implemented as a control layer interposed between the archive application and the vendor supplied archive device driver 20. Typically, the archive device driver 20 is provided as a kernel resident device driver conformant with the programming interface architecture of the operating system implemented by the host computer system 12. The secure archive driver 28 is preferably also provided as an operating system conformant device driver that presents to the archive application 22 as just another well-known archive device driver. In an alternate preferred embodiment, the secure archive driver 28 may be implemented as a wrapper around the archive device driver 20, effectively hiding and potentially securing the archive device driver 20 from use by the archive application 22 and other applications. For the presently preferred embodiment, the archive device driver 20 and the secure archive driver 28 both appear to the archive application 22 as equally available archive device drivers of well-known type.

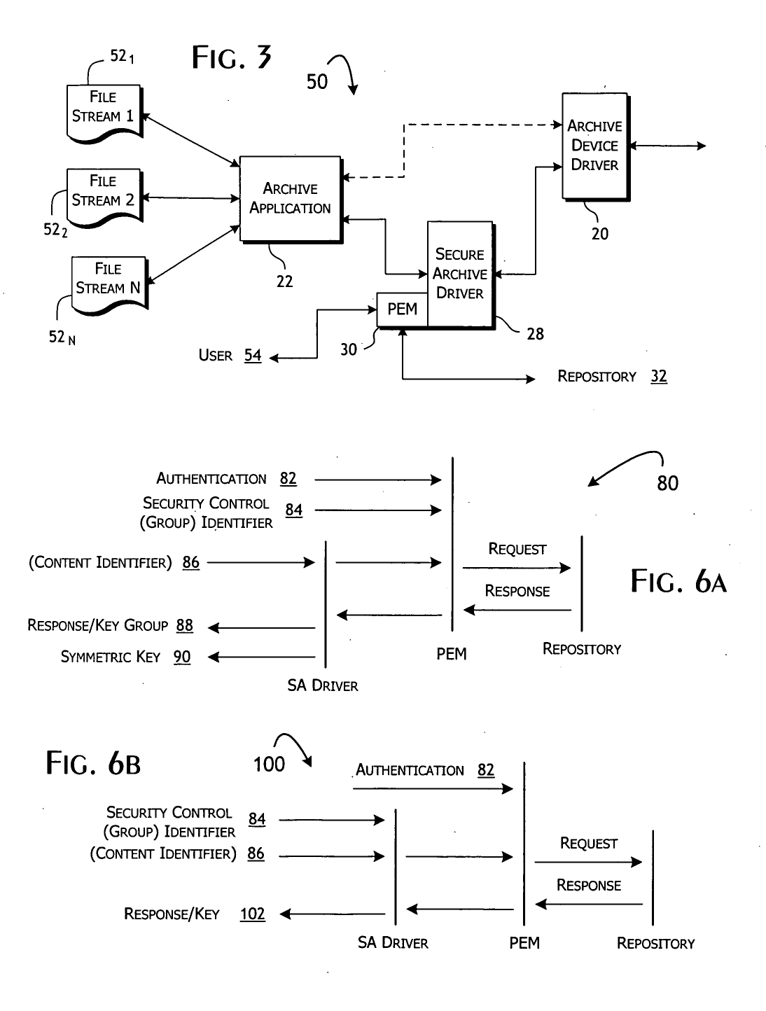

As generally illustrated in FIG. 3, the secure archive driver 28 preferably functions as an archive data processing proxy that relies on the archive device driver 20 to actually perform the archive data storage and retrieval operations requested by the archive application 22. That is, the public interface of the secure archive driver 28 represents an emulation interface of a known archive device driver having a relatively comprehensive set of archive device control features. Thus, by conventional administrative configuration of the archive application 22, effectively independent of the specific third-party implementation of the archive application 22, archive data streams 52_{1-N} are preferentially directed to and processed through secure archive driver 28. Additionally, all features and functions implemented by the particular third-party vendor implementation of the archive device driver 20, remain accessible in the presence of the secure archive driver 28 by proxy passthrough by way of the emulated archive device driver interface presented by the secure archive driver 28.

Operation of the secure archive driver 28 is preferably controlled by a policy enforcement manager (PEM) 30. The underlying operation of the secure archive driver 28 is to selectively encrypt and decrypt the archive data stream transferred through the secure archive driver 28. The PEM 30 preferably operates to observe the transfer of data and qualify the ciphering operation of the secure archive driver 28, including as appropriate obtaining encryption keys from a secure repository server 32 for use by the secure archive driver 28 and to authenticate, directly or indirectly as available, the user or operator 54 of the archiving application 22. In the preferred embodiments of the present invention, the secure policy server 32 is used to store and qualify access to sets of encryption keys. The secure policy server 32 may be implemented on a remote-server, as generally shown in FIG. 1, or included as a largely software-based component of the host computer system 12.

A clear text archive data stream 60, typically as presented to the secure archive driver 28 initially for processing, is illustrated in FIG. 4. At least in logical format order, an archive session metadata header 62 is initially provided by the archive application 22. The archive session metadata header 62 is typically a proprietary data structure that, in general, identifies the make and version of the archive application 22, an archive session creation date, a catalog of archive data sources, whether the clear text data is compressed, whether the archive device should perform hardware-based data compression, and any applicable data compression algorithm parameters. Typically, a session or volume number and other bookkeeping metadata sufficient to identify the nature and scope of the archive operation that created the archive data stream 60 is also included in the archive session metadata header 62. As is typical of archive applications 22, each subsequent content block, organized in a stream sequence of archive units 64_{1-N} is logically structured to include an archive unit metadata header 66_{1-N} and corresponding archive unit content segment 68_{1-N}. Each archive unit metadata header 66_{1-N} typically includes a linking session or volume identifier and a sequence number, thereby identifying logical participation in a particular archive data stream 60, and metadata descriptive of the file data included archive unit content segment 68_{1-N}.

In accordance with the present invention, an archive data stream 60 is modified to incorporate a security control identifier and to selectively encrypt the content segments 68_{1-N}. For the preferred embodiments of the preset invention, the incorporation of the security control identifier is accomplished by including the identifier in an available session description field conventionally provided by the archive application 22. Typically, a session description field is an otherwise empty text field offered by the archive application 22 to allow an administrator to add a custom text string to describe the type or instance of the archive session. The archive application 22 directly transcribes this text string into an optionally used field within the archive session metadata header 62, or into each of the metadata headers 66_{1-N} or both. Relative to the operation of the archive application, the text string is entirely non-functional in that the presence, absence, or content of the string has no affect on the operational function of the archive application 22; the content of the field is thus functionally transparent to the archive application 22. If an ordinary description field is not available, then any other functionally transparent field that occurs in the session metadata header 62, or in the metadata headers 66_{1-N} can be used. Alternately, if the archive application 22 is implemented in contemplation for use with the present invention, a dedicated field may be specifically provided, preferably in the session metadata header 62.

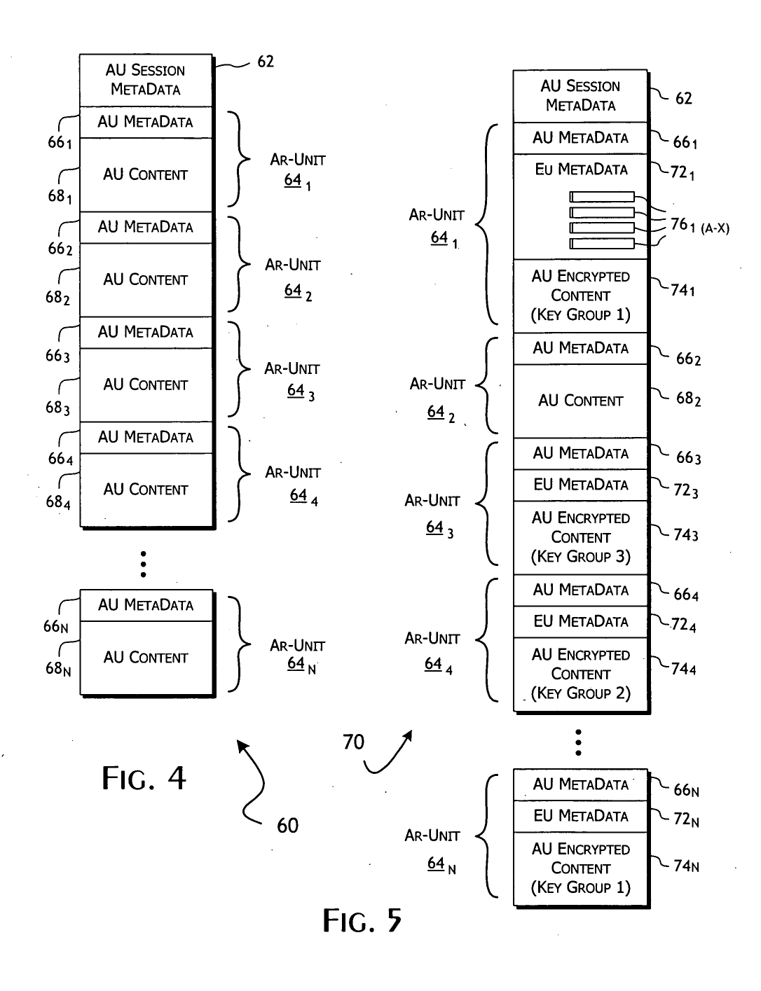

The security control identifier is preferably created by operation of the PEM 30. In the preferred embodiments, a GUI may be presented to the user 54 to assist in the creation of the identifier. Once created, the security control identifier is inserted into the chosen descriptive field within the session metadata header 62, as is preferred, or metadata headers 66_{1-N}, as received by the secure archive driver 28 from the archive application 22. As generally shown in FIG. 5, the archive data stream is further processed through the secure archive driver 28 to provide a secured, persistable stream 70.

In the preferred embodiments, the individual archive units 64_{1-N} are processed by the secure archive driver 28 dependent on the security control identifier specified for the session that the archive units 64_{1-N} belong to and, optionally, the content source of the archive data contained in each of the archive units 64_{1-N} Consequently, the system 10 implemented by the present invention is not only tolerant, but fully supports any interleaving of archive units 64_{1-N} belonging to different archive sessions by the archive application 22. Furthermore, the system 10 can potentially vary the security controls applied to the data being archived based on the particular source of the data, as defined in the metadata headers 66_{1-N} typically in terms of a universal resource identifier (URI) or source filesystem.

The secure archive driver 28 preferably functions to encrypt and, optionally, compress the data contained in an archive unit 64_{1-N}. For example, considering an archive unit 64₁ as representative of the archive units 64_{1-N} a content segment 68₁ is encrypted and replaced in the archive data stream 60 by the combination of an encryption metadata header 72₁ and encrypted content segment 74₁. For the preferred embodiments of the present invention, a symmetric encryption key is generated for the archive unit 64₁ and used to create the encrypted content segment 74₁. This symmetric key is then encrypted using the public encryption key members of a group of public key encryption key pairs. The multiple encrypted copies 76_{1 (A-X)} of the symmetric key for the encrypted content segment 74₁ are then stored in the encryption metadata header 72₁. The metadata header 66₁, encryption metadata header 72₁ and encrypted content segment 74₁ then constitute a replacement archive unit 64₁. The replacement archive units 64_{1-N} including any selectively determined not be processed, such as the archive unit 64₂, are substituted by the secure archive driver 28 to create the archive data stream 70.

In the preferred embodiments of the present invention, the archive units 64_{1-N} are discretely processed to accommodate the potential interleaving of archive units from different archive sessions in the archive stream and to allow differential encryption control based on source content identifiers or other qualifying information contained in the archive unit metadata headers 66_{1-N}. As generally illustrated in FIG. 5, the archive units 64₁ and 64_{N} are encrypted subject to the same security controls; specifically, subject to the same security control identifier, though potentially with a different symmetric key. The archive units 64₃ and 64₄ are encrypted subject to different security controls, either as belonging to a different session having a different security control identifier or referencing a different source content location in either or both of the corresponding metadata headers 66_{2,3}.

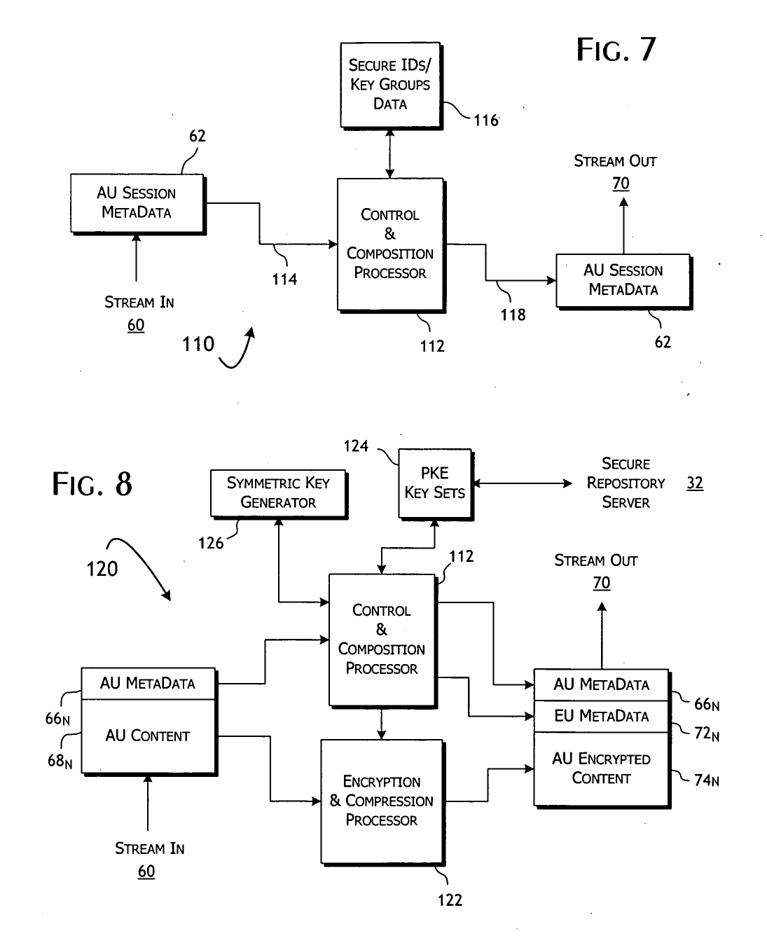

The preferred process 80 of resolving a security control identifier for purpose of enabling the processing of the archive units 64_{1-N} is generally shown in FIG. 6A. An authentication token or equivalent data 82 is obtained either from the user or operator 54 or from the security system implemented by the underlying operating system implemented by the host computer system 12. The security control identifier 84 is obtained from the user or operator 54 typically through a GUI presented by the PEM 30. For future reference, the PEM 30 may back populate a configuration file used by the archive application 22 to persist the security control identifier, equivalent to the security control identifier having been simply entered as a descriptive text string using the administrative GUI provided by the archive application 22 itself. In this case, the security control identifier is received by the secure archive driver 28 and passed to the PEM 30.

In the preferred embodiments of the present invention, the security control identifier is a string list of one or more names of security control groups predefined on the security repository server. For example, a security control identifier may be defined as “corpA-admin01, corpA-division04,” where the secure repository server stores, subject to authenticated access, one group of encryption keys associated with the identifier “corpA-admin01” and another group of encryption keys associated with the identifier “corpA-division04.” Each of these groups may contain one or more encryption keys.

For a given archive unit 64_{1-N} then, the authentication token 82, security control identifier 84, and, optionally, a content identifier 86 extracted from the corresponding metadata header 66_{1-N} and passed to the PEM 30 are then presented as a request to the secure repository server 32. Provided the authentication token 82 is enabled, subject to the authentication rules implemented by the repository 32, the collected encryption keys 88 referenced by the security control identifier 84 are returned. These encryption keys 88 may be non-persistently cached by the PEM 30. On the implied confirmation that encryption is enabled for this given archive unit 64_{1-N} the secure archive driver 28 generates a symmetric key 90. The corresponding content segment 68_{1-N} is encrypted with the symmetric key 90 and a corresponding encryption metadata header 66_{1-N} is created. The symmetric key 88 is encrypted with each of the keys contained in the returned group of keys 88, and stored in a slot data structure 76_{1-N (A-X)} within the corresponding encryption metadata header 66_{1-N}.

The preferred process 100 of resolving a security control identifier for the purpose of reverse processing the archive units 64_{1-N} is generally shown in FIG. 6B. In similar manner as above, a secure authentication token 82 is obtained by the PEM 30. A secure control identifier 84 is extracted by the secure archive driver 28 for each session stream transferred though the secure archive driver 28. For each archive unit 64_{1-N} received, the content identifier is optionally extracted and passed with an identification of the corresponding session to the PEM 30. This request is forwarded with the authentication token 82 to the secure repository server 32. Given the specific identification of the user or operator 54 provided by the authentication token 82, the groups of encryption keys identified by the security control identifier 86 are searched for a match. A response 102 is returned to the secure archive driver 28, selectively including a decryption key depending on whether a secure match was found. In the absence of a decryption key, the corresponding archive unit 64_{1-N} is passed through the secure archive driver 28 without modification.

Notably, all attempts to access the content of a secure data session require access requests to be posted to and resolved by the secure repository server 32. Preferably, the secure repository server 32 implements an access request log to collect general and administrative operating information, such as system initialization, shutdown, and restart, and network connects and disconnects between different client/server components, and backup and restore operation requests of critical security parameters (CSPs), including hosts, policies, and keys. Operational information related to individual and groups of access requests will also be logged, including the request time, the network identification of the system originating the request and the resulting response, and the requested backup and restore archive actions. Each logging event is preferably stored with a timestamp, event type identifier, severity value, subsystem identifier, success value, object (key, policy, host, etc.) accessed as part of the action, and an optional action description. Consequently, the present invention provides a well-defined auditing mechanism for all secured session data accesses, including both succeeded and failed requests.

Where a decryption key is returned 102, the secure archive driver 28 decrypts a corresponding one of the encrypted symmetric keys 76_{1-N (A-X)}. Preferably, the decryption key is applied sequentially to the encrypted symmetric keys 76_{1-N(A-X)} and the decryption verified preferably using an envelope encryption verification or other known-text verification technique. Once verified decryption of a symmetric key is achieved, the symmetric key is used to decrypt the corresponding content segment 68_{1-N}. The encryption metadata header 72_{1-N} is discarded, and the resulting clear text archive unit 64_{1-N} is substituted into the archive data stream.

A preferred implementation 110 of the secure archive driver 28, relative to the processing of session metadata headers, is shown in FIG. 7. A control and composition processor 112 is preferably implemented as a primary control module within the secure archive driver 28. As archive unit metadata headers 62 are received 114 from the input archive data stream 60, the control and composition processor 112 identifies the header format from an internal catalog of known archive application 22 session header identifiers. Where an archive unit metadata header 62 is received from the archive application 22, the control and composition processor 112 checks for and typically updates the metadata header 62 to contain a valid control identifier. The PEM 30 monitors the operation of the control and composition processor 112 to access and provide an appropriate secure identifier from an identifier store 116 preferably maintained securely within the PEM 30. The contents of the key store 166 are preferably verified, through operation of the PEM 30, against the contents of the secure repository server 32. The modified archive unit metadata headers 62 are then substituted 118 into the outbound archive-data stream 70.

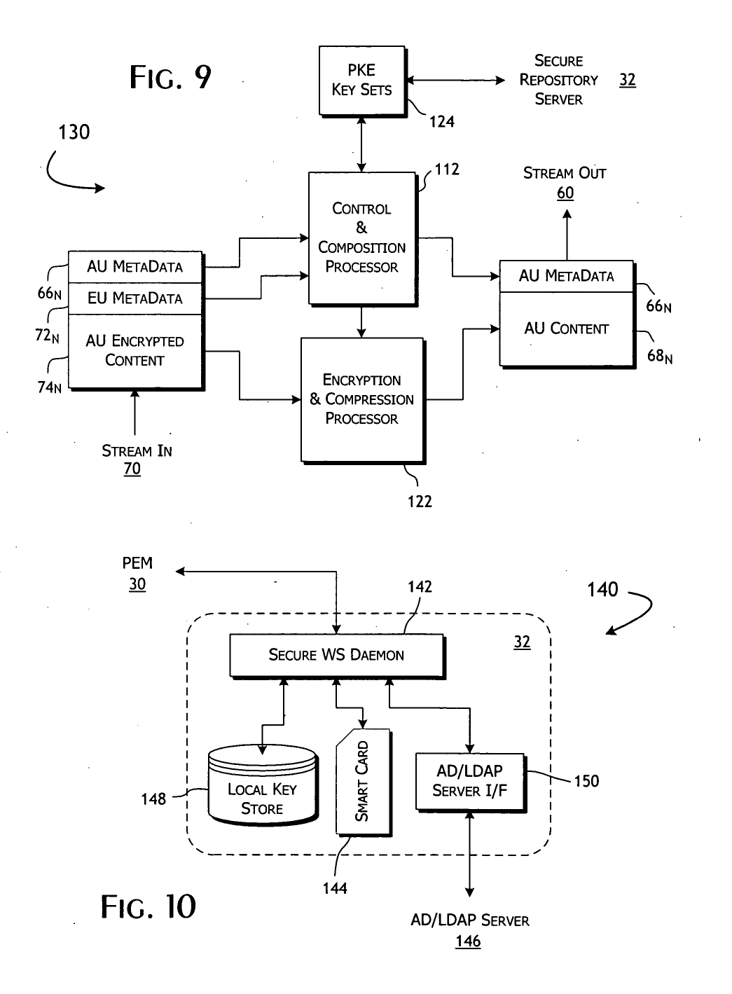

FIG. 8 illustrates the preferred implementation 120 of the secure archive driver 28 relative to the processing of archive units 64_{1-N}. As archive units 64_{1-N} are received from the archive application 22, the metadata headers 66_{1-N} are processed through the control and composition processor 112 to extract session and, as appropriate, content identifiers. The control and composition processor 112 posts a request for the group keys to and through a key set store 124 maintained preferably as a secure cache store within the PEM 30. The contents of the key set store 124 are preferably backed, through the operation of the PEM 30, by the secure repository server 32. On return of one or more key sets, specifically the public members of the applicable group key pairs, a symmetric key is obtained from a random symmetric key generator 126 provided within the secure archive driver 28. The symmetric key is provided to an encryption and compression processor 122. Compression control parameters, including a flag determining whether compression is to be effected is either encoded in the secure control identifier or, preferably, returned from the repository server 32 as control information accompanying the encryption key groups. The control and composition processor 112 is responsible for assembling the replacement archive units 64_{1-N} and placing them in the outbound archive data stream 70. Where an archive unit 64_{1-N} is not identified for encryption or compression processing, the control and composition processor 112 preferably operates to pass the affected archive unit 64_{1-N} directly into the outbound archive data stream 70.

The reverse processing 130 of archive units 64_{1-N} through a preferred embodiment of the secure archive driver 28 is shown in FIG. 9. The archive unit metadata headers 66_{1-N} and encryption metadata headers 66_{1-N} of the archive data stream 70, as received from an archive device driver 20, are processed by control and composition processor 112. Recovery of session identifiers from the archive metadata headers 66_{1-N} allows the control and composition processor 112 to identify the applicable session security control identifiers either typically by reference to the identifiers recorded from the archive unit session headers 62 previously processed through the archive data stream 70. As applicable, content identifiers are also extracted from the archive metadata headers 66_{1-N}. Requests for content segment applicable decryption keys are posted to the key set store 124 of the PEM 30. Where candidate decryption keys are returned, the control and composition processor 112 verifiably decrypts a copy of the symmetric encryption key stored in the corresponding encryption metadata headers 66_{1-N}. Recovered symmetric encryption keys are used by the encryption and compression processor 122 to construct clear-text content segments 68_{1-N} from encrypted content segments 74_{1-N}. Compression parameters are also recovered from the encryption metadata headers 66_{1-N} and used, as applicable, to decompress decrypted content segments 74_{1-N}. As before, the control and composition processor 112 is responsible for assembling the replacement archive units 64_{1-N} and placing them in the outbound archive data stream 60.

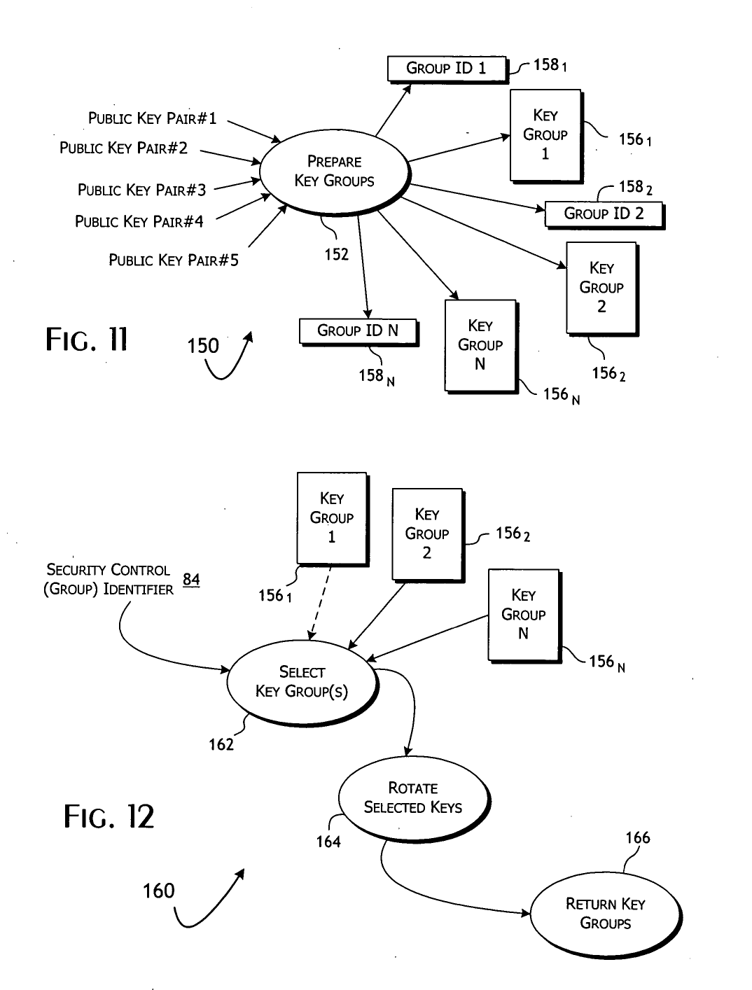

A preferred embodiment 140 of a secure repository server 32 is shown in FIG. 10. To enable convenient use in a variety of operational scenarios, the secure repository server 32 is preferably implemented as a secure web services module 142 executable as a daemon process either on a host computer system 12, another server computer system typically executing a conventional network operating system, generally as indicted in FIG. 1, or similarly on an appliance computer system using an embedded network operating system. Implementation is simplified by standardizing on a daemon process architecture, rather than kernel-based. Similarly, providing access using a standard web services protocol simplifies system administration and network proxy management.

Upon receipt of a web service request, the secure web services daemon 142 qualifies the request against the authentication token. In the preferred embodiments of the present invention, the authentication token is verified against either a locally accessible smart card 144, or similar security device, or external security server 146 implementing an active directory or LDAP security service. Where the authentication token is verified, the request is considered. To process and secure a new archive session, a local key store 144 is accessed to retrieve the security control identifier determined encryption key groups. To recover a secure archive session, the private key member of the encryption key pair identified by the authentication token is retrieved from the local key store 144. Both the initial request and eventual response by the secure web services daemon 142 is transferred through a secure network connection with the requesting PEM 30.

The preparation of encryption key groups, for use in accordance with the present invention, is preferably performed on a secure archive management computer system that hosts the secure repository server 32 or that can securely connect to the secure repository server 32. An administrative process 150, as shown in FIG. 11, is used to collect public key encryption key pairs into administratively defined key groups 156_{1-N}. Each of the key groups 156_{1-N} is assigned a unique text identifier 158_{1-N}. The criteria for grouping keys is administratively determined, typically on the basis of a commonality of access needs and rights. For example, a management group is typically defined to contain the master keys used by the archiving entity, corporation or business, to ensure historical accessibility. Other key groups are typically defined for the department or business unit that generated the archive data and for an organization or other entity, whether internal or external to the archive data originating department, that is designated as having the right to read, review, or audit the archived data. The resulting discrete key groups 156_{1-N} are then stored to the local key store of the secure repository server 32, indexed by the corresponding unique text identifiers 158_{1-N}.

For the preferred embodiments of the present invention, a variety of information can be extracted from the host computer system 12 and archive data streams 60 that can be used to identify and qualify the use of discrete key groups 156_{1-N}. Information identifying the host computer system 12, the archive application 22, and the content of an archive data stream 60 can be processed by PEM 30, whether obtained directly by the PEM 30 or through the secure archive driver 28, to create an attribute set that is sent as part of a request to the secure repository server 32. Preferably, the attribute set includes the security control identifier, authentication token, the user name or ID of the process owner running the archive application, the IP address and DNS name assigned to the host computer system 12, the group user id (GUID) and hardware device identifier specified by the archive application 22, and information extracted from fields existing within the archive metadata header 62 and archive unit metadata headers 66_{1-N}, including descriptive keywords and the filesystem metadata identifying the archived content. The attribute set may also include an archive application identifier, the command line string used to invoke the archive application.

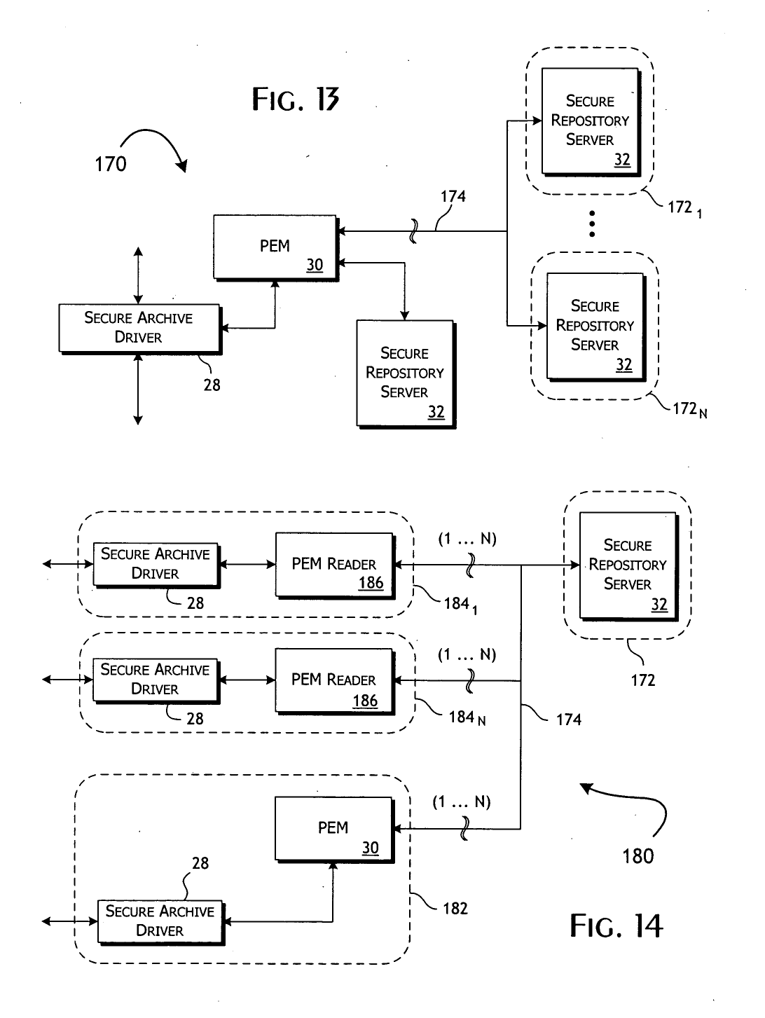

A preferred process 160 of selectively retrieving encryption key groups 156_{1-N} for use in the encryption processing of an archive session is illustrated in FIG. 12. The secure repository server 32 operates in response to a request to return the encryption key pairs associated with the key groups identified by the concurrently provided security control identifier 84, preferably further qualified by a content identifier 86 and other attribute set data. In response, the secure repository server 32 identifies 162 the corresponding key groups, here shown as including at least key groups 156₂ and 156_{N}. In accordance with the present invention, the encryption key groups 156_{1-N} may include additional encryption key pairs in any or all of the encryption key groups 156_{1-N} to support encryption key rotation. That is, for example, a division or other entity may have two or more assigned public encryption key pairs for use in archiving data. The access rights associated with this rotation subgroup are otherwise identical. The secure repository server, based on an administratively defined schedule, sub-selects 164 in rotation one of the available public encryption key pairs as the representative member of the corresponding key group 156_{1-N} then actually returned 166 in response to the initial request. Key rotation, in this manner, reduces the security exposure should any one of the encryption keys in a rotation group be compromised.

A secure archiving system constructed in accordance with the present invention can be distributed and operated in a variety of modes relative to the location and number of available secure repository servers 32. As generally shown in FIG. 13, a PEM 30 of a secure archiving system 170 can connect with and use a local secure repository server 32 co-resident and executed on the some host computer system 12. Consistent with the preferred web services implementation of the secure repository server 32, a secure local network-based connection is supported between the PEM 30 and secure repository server 32.

Alternately or in addition, remote systems 172_{1-N} implemented in any combination of server computer systems and appliances, can support separate secure repository servers 32. These remote systems 172_{1-N} are preferably accessible through secure network connections 174. For the preferred embodiments, each of these remote systems 172_{1-N} can store the same and different sets of key groups 156_{1-N} providing generalized redundancy as well as allowing specialization as administratively determined appropriate for the combined network of remote systems 172_{1-N}. Preferably, the PEM 30 maintains a persistent list of the remote systems 172_{1-N} administratively updateable or automatically updateable from any of the remote systems 172_{1-N} potentially whenever a connection is made to any of the remote systems 172_{1-N}. This configuration allows the PEM 30 to search a variety of secure repository servers 32 for the necessary information to enable operation.

Another secure archiving system configuration 180 is shown in FIG. 14. As before, a secure archiving system 182 is deployed with access through a network 174 to remote systems 172_{1-N} hosting secure repository servers 32. In addition, one or more restricted or affiliate secure archive reader systems 184_{1-N} are provided also with network access to the remote systems 172_{1-N}. The affiliate systems 184_{1-N} each preferably implements a restricted PEM 186 that differs from a standard PEM 30. The specific differences are, in the preferred embodiments, optional with the effect of controlling the archive data streams that the restricted PEM 186 allows for processing by the associated secure archive driver 28. The preferred set of restrictions include a restriction against the creation of a secure archive stream, thereby enforcing read-only operation. Another restriction is a limitation to using a predefined authentication token in requests to a secure repository server 32, thereby constraining the access to secure archive data to a well-defined set. Implementing this limitation enables an administrator to effectively control or revoke the access privileges of the corresponding affiliate systems 184_{1-N} by altering the key groups 156_{1-N} stored by the secure repository servers 32. Additionally, administrative restrictions on access to the key groups 156_{1-N} based on the domain address of the affiliate systems 184_{1-N} or unique identifiers assigned to the individual restricted PEMs 186 can be established to selectively restrict operations of the affiliate systems 184_{1-N} Removal of the key groups 156_{1-N} from the secure repository servers 32 of the accessible remote systems 172_{1-N} will globally revoke all access rights.

Thus, a system and methods for providing for the secure archiving of data has been described. While the present invention has been described particularly with reference to tape and hard disk-based storage media, the present invention is equally applicable to other forms of media and corresponding variety of media control systems.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A secure data archiving system comprising:
a) a data storage stack provided for execution on a host computer system, wherein said data storage stack includes an archiving application, a data storage device and a storage device driver, wherein said archiving application provides for the controlled transfer of an archive session data stream through said storage device driver with respect to said data storage device, wherein said archive session data stream includes a session header and a plurality of data segments, and wherein said session header includes predetermined data;
b) a secure storage control layer interposed between said archiving application and said storage device driver and provides for the transport of said archive session data stream thereinbetween, said secure storage control layer including an encryption engine providing for the selective cipher processing of said plurality of data segments; and
c) a secure policy controller coupled to said secure storage control layer and responsive to said predetermined data to identify an encryption key retrievable by said secure policy controller from a secure storage repository, said secure policy controller being operative to provide said encryption key to said encryption engine.

2. The secure data archiving system of claim 1 wherein said session header has a predetermined structure defined by said archiving application and wherein said predetermined data is included in and persisted with said session header functionally transparent to said archiving application.

3. The secure data archiving system of claim 2 wherein said secure policy controller decodes said predetermined data to identify said encryption key, said secure policy controller further including means for determining an authorization to use said encryption key.

4. The secure data archiving system of claim 3 wherein said encryption key enables the selective cipher processing of said data segments.

5. The secure data archiving system of claim 4 wherein said predetermined data identifies a predetermined group of encryption keys persisted in a secure repository, wherein said predetermined group of encryption keys includes said encryption key, wherein said authorization selectively enables retrieval of said encryption key from said secure repository from among said predetermined group of encryption keys.

6. A method of archiving data subject to multiple secured data access controls, wherein data segments making up an archive session are streamed between an archive application and an archive device, said method comprising the steps of:
a) extracting from a predetermined archive session stream an identifier of a predetermined access control group, wherein said predetermined access control group is one of a plurality of identifiable access control groups that each include a predefined set of encryption keys, said identifier being embedded in said predetermined archive session stream functionally transparent with respect to said archive application and said archive device;
b) accessing said predetermined access control group to obtain a predetermined encryption key included within said predetermined access control group; and
c) applying said predetermined encryption key to an encryption engine provided between said archive application and said archive device; and
d) processing said predetermined archive session stream through said encryption engine.

7. The method of claim 6 wherein said step of accessing includes the step of evaluating said predefined set of encryption keys included in said predetermined access control group to securely validate selection of said predetermined encryption key.

8. The method of claim 7 wherein said step of processing includes, with respect to a predetermined encrypted data segment of said predetermined archive session stream, a first step of decrypting, using said predetermined encryption key, a segment encryption key from said encrypted data segment, and a second step of decrypting, using said segment encryption key, segment data from said encrypted data segment.

9. The method of claim 7 wherein said step of processing includes, with respect to a predetermined clear-text data segment of said predetermined archive session stream, the steps of:
a) encrypting, using a predetermined segment encryption key, said predetermined clear-text data segment to produce a predetermined encrypted data segment; and
b) associating said predetermined segment encryption key, encrypted using said predetermined encryption key, with said predetermined encrypted data segment in said predetermined archive session stream.

10. A secure data archiving system implemented through the execution of system components on a secure storage server computer coupled to persistent storage media, said secure data archiving system comprising:
a) an archiving application that controls an archive session wherein an archive data stream is transferred between an archive device and said archiving application, said archiving application providing for the persistent storage of session ancillary data as part of said archive session;
b) a data security driver interposed between said archiving application and said archive device with respect to said archive data stream, said data security driver including a data processor that provides for the recovery of said session ancillary data from said archive data stream and selective cipher processing of data segments transferred within said archive data stream; and
c) a policy management controller coupled to said data security driver to receive said session ancillary data and responsively provide, selectively dependent on predetermined policy management controls, a session encryption key to said data security driver.

11. The secure data archiving system of claim 10 wherein said session ancillary data is non-functional data with respect to said archiving application and wherein said ancillary data is processed by said policy management controller to functionally identify a policy group of encryption keys applicable to a predetermined data segment transferred within said archive data stream.

12. The secure data archiving system of claim 11 further comprising a secure repository providing for the persistent storage of a plurality of policy groups of encryption keys, wherein each of said plurality of policy groups is uniquely identifiable by said policy management controller in response to the processing of said ancillary data.

13. The secure data archiving system of claim 12 wherein said policy management controller is operative to obtain an authenticated identifier and, responsive to said authenticated identifier, further operative to select a predetermined encryption key from said policy group of encryption keys as said session encryption key and provide said session encryption key to said data security driver, wherein said data security driver is operative with respect to said session encryption key to enable selective cipher processing of said predetermined data segment.

14. The secure data archiving system of claim 13 wherein said data security driver is operative to decrypt a segment encryption key from said predetermined data segment by application of said session encryption key to said predetermined data segment.

15. The secure data archiving system of claim 13 wherein said data security driver is operative to encrypt said predetermined data segment using a segment encryption key, said data security driver being further operative to encrypt, using said predetermined session encryption key, and attach said segment encryption key to said predetermined data segment, as encrypted.

16. A secure data archiving system comprising:
a) a server computer system including an archiving application operative to transfer an archive data stream with respect to an archive data storage device, said archive data stream including a series of archive data units wherein each said archive data unit includes a first metadata unit and a data segment;
b) a security driver interposed between said archiving application and said archive data storage device, said security driver including an encryption controller provided to selectively process said archive data stream, wherein for a selected archive data unit, said encryption controller is operative to replace said data segment of said selected archive data unit with a second metadata unit and an encrypted data segment produced by encryption of said data segment of said selected archive data unit using a predetermined encryption key, said encryption controller being further operative to encode said predetermined encryption key into said second metadata unit.

17. The secure data archiving system of claim 16 wherein said encryption controller is further operative to multiply encode said predetermined encryption key into said second metadata unit.

18. The secure data archiving system of claim 17 further comprising a policy controller, wherein said encryption controller is coupled to said policy controller to receive a set of encryption keys, and wherein said encryption controller is operative to encode said predetermined encryption key into said second metadata unit using respective ones of said set of encryption keys.

19. The secure data archiving system of claim 18 wherein said policy controller is coupleable to a secure repository that enables the retrieval of said set of encryption keys.

20. The secure data archiving system of claim 19 wherein said encryption controller is operative to extract predetermined policy information from said archive data stream, wherein said policy controller is responsive to said predetermined policy information to determine the selection of said set of encryption keys from said secure repository.

21. A method of securing archive data as transferred through a computer system, said method comprising the steps of:
a) intercepting an archive data stream in transit between an archiving application and an archive device, said archive data stream including a series of data units, wherein each said data unit includes a unit metadata header and a data segment;
b) processing said series of data units wherein, for a predetermined data unit, said processing step substitutes a replacement data unit for said predetermined data unit in said archive data stream, said processing step including the steps of:
i) selecting a segment encryption key corresponding to said predetermined data unit;
ii) first encrypting said data segment of said predetermined data unit with said segment encryption key to produce an encrypted data segment;
iii) second encrypting said segment encryption key by each of a set of security control encryption keys and storing said segment encryption key, as encrypted, in a security metadata header; and
iv) packaging said unit metadata header, said security metadata header and said encrypted data segment as said replacement data unit.

22. The method of claim 21 wherein said step of processing further includes the step of selectively generating said segment encryption key and wherein each said set of security control encryption keys is a member of an asymmetric encryption key pair.

23. The method of claim 22 further comprising the steps of:
a) obtaining from said archive data stream a set of encryption group identifiers; and
b) retrieving, based on said set of encryption group identifiers, said set of security control encryption keys.

24. The method of claim 23 wherein said step of retrieving provides for the retrieval of said set of security control encryption keys from a secure repository.

25. A secure data archiving system comprising:
a) a server computer system including a data archive device, an archive driver coupled to said data archive device, and a data archiving application program executed by said server computer system to provide for the transfer of a data stream between said data archiving application and said data archive device through said archive driver, wherein said data stream includes an archive data session having a archive session header and a series of archive units wherein each archive unit includes a metadata header and a payload data segment; and
b) an archive data security layer coupled between said archive driver and said archiving application program, wherein said archive data security layer includes an encryption controller operative to selectively encrypt said payload data segments of said archive data session within said data stream, said encryption controller being further operative to securely encode a predetermined encryption key used to encrypt said payload data segments into an encryption header included in said archive data session within said data stream.

26. The secure data archiving system of claim 25 further comprising a policy enforcement module coupled to said archive data security layer, said policy enforcement module being coupleable to a secure data repository, wherein said policy enforcement module is responsive to predetermined session control data encoded in said archive session header functionally transparent to said data archiving application to determine the selection of a group policy set of encryption keys from said secure data repository, wherein said encryption controller is operative to respectively encode said predetermined encryption key into said encryption header using the member encryption keys of said group policy set.

27. A secure data archiving system comprising:
a) a server computer system including a data archive device, an archive driver coupled to said data archive device, and a data archiving application program executed by said server computer system to provide for the transfer of a data stream between said data archiving application and said data archive device through said archive driver, wherein said data stream includes an archive data session having a archive session header and a series of archive units wherein each archive unit includes a metadata header and a payload data segment; and
b) an archive data security layer coupled between said archive driver and said archiving application program, wherein said archive data security layer includes an encryption controller operative to read an encryption header included in said archive data session within said data stream to decode a predetermined encryption key from said encryption header, said encryption controller being further operative to selectively decrypt said payload data segments of said archive data session within said data stream using said predetermined encryption key.

28. The secure data archiving system of claim 27 further comprising a policy enforcement module coupled to said archive data security layer, said policy enforcement module being coupleable to a secure data repository, wherein said policy enforcement module is responsive to predetermined session control data encoded in said archive session header functionally transparent to said data archiving application to determine the selection of a group policy set of encryption keys from said secure data repository, wherein said encryption controller is operative to verifiably decode said predetermined encryption key from said encryption header using one of the member encryption keys of said group policy set.

29. A system for selectively controlling access to a data archive, said system comprising:
a) an archive, hosted by a media server computer system, providing for the persistent storage of data organized logically as archive sessions, wherein a predetermined archive session contains session metadata, a first plurality of archive metadata segments and a second plurality of archive data segments, wherein said archive data segments are encrypted and wherein, for a given archive data segment, a data segment encryption key is encoded in a given archive metadata segment having a defined correspondence to said given archive data segment;
b) a secure repository server storing sets of encryption keys, said secure repository server being responsive to a policy identifier for the selection of a corresponding one of said sets of encryption keys; and
c) an archive data reader, hosted by a client computer system, coupleable to said media server computer system for access to said predetermined archive session, said archive data reader being operative to present an authentication token and said policy identifier, as obtained from said session metadata, to said secure repository server to access said corresponding one of said sets of encryption keys, said archive data reader being operative, given said corresponding one of said sets of encryption keys, to decode said data segment encryption key from said given archive metadata segment and decrypt said given archive data segment.

30. The system of claim 29 wherein said archive data reader includes a policy controller operative to retrieve, based on said authentication token and said policy identifier, a predetermined encryption key from said corresponding one of said sets of encryption keys, said policy controller being further operative to transiently maintain said predetermined encryption key subject to predetermined use controls.

31. The system of claim 30 wherein said policy controller transiently maintains said predetermined encryption key for the duration of an archive data read session.

32. The system of claim 30 wherein said policy controller transiently maintains said predetermined encryption key for a predetermined period of time.

33. The system of claim 30 wherein said policy controller transiently maintains said predetermined encryption key for the duration of a predetermined number of archive data read sessions.

34. The system of claim 30 wherein said secure repository server is one of a plurality of secure repository servers that can equivalently perform as said secure repository server.

35. The system of claim 34 wherein said plurality of secure repository servers are coupleable to said archive data reader through a communications network.

36. The system of claim 35 wherein said archive data reader is one of a plurality of archive data readers that can equivalently perform as said archive data reader and wherein said plurality of archive data readers are coupleable to said media server system through said communications network.

37. A method of securely controlling the reading of archive data from an archive data media server by users of archive data reader computer systems, said method comprising the steps of:
a) defining identification tokens for use by subgroups of a plurality of archive data reader users;
b) enabling the transfer of an archive data stream representing an archive data session from an archive data media server to a requesting archive data reader computer system;
c) retrieving an encryption key from a secure repository server dependent on presentation of a defined identification token and a group identifier obtained from said archive data stream;
d) first decrypting, using said encryption key, a session encryption key from said archive data stream; and
e) second decrypting, using said session encryption key, data from said archive data stream, wherein said step of first decrypting is conditional dependent on a security policy under which said archive data session was created.

38. The method of claim 37 wherein said group identifier selects a predefined group of encryption keys stored by said secure repository server, the specific encryption keys included in said predefined group being determined by said security policy, said method further comprising the step of determining if said encryption key is present in said predefined group of encryption keys, whereby said step of first decrypting is selectively blocked based on said security policy.

39. The method of claim 38 further comprising the step of recording, by said secure repository server, predetermined identifying information presented to said secure repository server in connection with said step of retrieving, whereby accesses of said archive data session are reliably auditable.
